(19) United States
(12) Patent Application Publication
(10) Pub. No.: US 2016/0016258 A1
(43) Pub. Date: Jan. 21, 2016

(54) WELD FOR DIFFERENTIAL ASSEMBLY

(71) Applicant: GM Global Technology Operations LLC, Detroit, MI (US)

(72) Inventors: Huaxin LI, Rochester Hills, MI (US); Martin HEFTER, Oxford, MI (US)

(21) Appl. No.: 14/657,534

(22) Filed: Mar. 13, 2015

Related U.S. Application Data
(60) Provisional application No. 62/025,721, filed on Jul. 17, 2014.

(51) Int. Cl. B23K 26/21; B23K 35/30; B23K 26/323

(52) U.S. Cl. CPC B23K 26/21; B23K 26/323; B23K 35/3033; B23K 2203/04

(57) ABSTRACT

A weld is employed to join two components of a differential assembly. The weld has a centerline tilted towards one of the two components to generate a stress release packet at a weld root of the weld. In some arrangements, the two components are made of dissimilar materials such as iron and carburized steel, and a high nickel alloy wire is employed as the weld filler metal. The carburized layer on the steel is not removed before the welding process, such that the weld is formed as a mixture of iron, carburized layer from the steel component, and the weld filler metal.

### RELATED APPLICATION

This application claims the benefit of U.S. Provisional Patent Application No. 62/025,721, filed on Jul. 17, 2014, the entire contents of which are incorporated herein by reference.

### FIELD

The present disclosure relates to a weld. More specifically, the present disclosure relates to a weld for a differential assembly.

### BACKGROUND

The statements in this section merely provide background information related to the present disclosure and may or may not constitute prior art.

A typical differential assembly for a motor vehicle transmission includes several components. For example, the differential assembly may include a housing and a differential cover attached to the housing. The cover may be bolted to the housing, or the cover and the housing may be welded together. When the cover and housing are welded together, the two components may be made of dissimilar material. In some arrangements, one component is made of carburized steel. In such arrangements, the carburized layer on the steel component is removed by machining, which adds costs and time to the assembly of the differential assembly.

### SUMMARY

The present invention provides a weld for joining two components of a differential assembly. The weld has a centerline tilted towards one of the two components to generate a stress release packet at a weld root of the weld. In some arrangements, the two components are made of dissimilar materials such as iron and carburized steel, and a high nickel alloy wire is employed as the weld filler metal. The carburized layer on the steel is not removed before the welding process, such that the weld is formed as a mixture of iron, carburized layer from the steel component, and the weld filler metal.

Further features, advantages, and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, emphasis instead being placed upon illustrating the principles of the invention. Moreover, in the figures, like reference numerals designate corresponding parts throughout the views. In the drawings:

FIG. 1 is perspective view of a differential assembly for a motor vehicle;

FIG. 2 is a cross-sectional view of a housing and a differential cover for a differential assembly joined together with v-shaped weld; and

FIG. 3 is a cross-sectional view of a housing and a differential cover of the differential assembly of FIG. 1 joined together with a weld in accordance with the principles of the present invention.

### DETAILED DESCRIPTION

The following description is merely exemplary in nature and is not intended to limit the present disclosure, application, or uses.

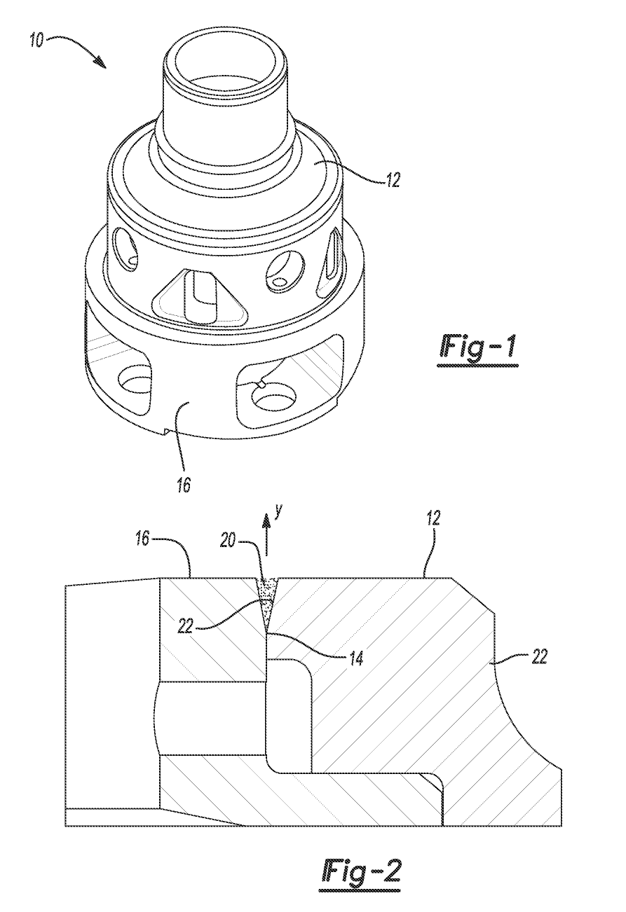

Referring now to FIG. 1, a differential assembly for a motor vehicle transmission is shown at 10. The differential assembly includes a differential cover 12 joined to a housing 16. In particular arrangements, the cover is made of carburized steel and the housing is made of ductile iron.

Referring also to FIG. 2, the differential cover 12 can be joined to the housing 16 with a v-shaped weld 20. Such a weld design, however, produces a weld root 14 at the tip of the v-shaped weld. This arrangement produces high stress concentration at the weld root 14 because of the introduction of a crack between the differential cover 12 and the housing 16 at the weld root 14. Moreover, with such an arrangement, the carburized steel cover 12 includes a carburized layer 22, which is removed by machining before the housing 16 and the cover 12 are welded together.

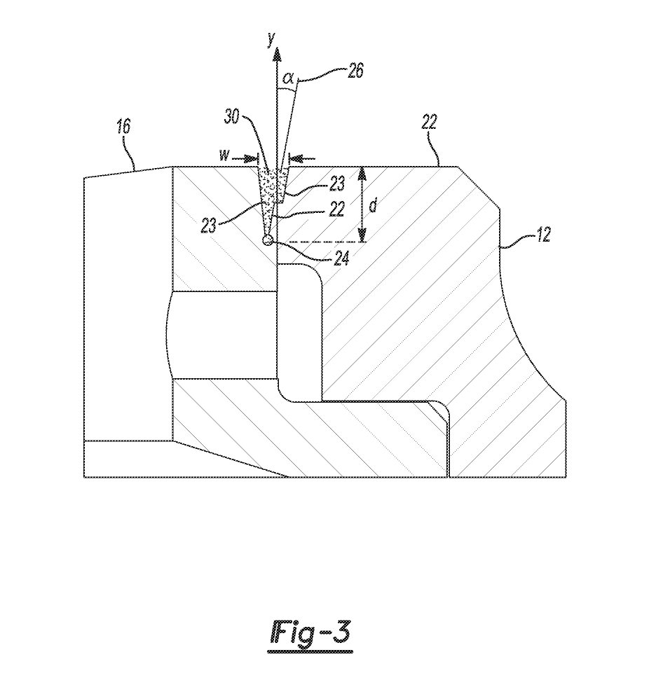

Referring now to FIG. 3, there is shown a tilted weld 30 that joins the housing 16 and the cover 12 in accordance with the principles of the present invention. The weld center line 26 is at an angle, α, from the y-axis. The tilted weld 30 has a depth, d, and a width, w, at the top of the weld. The depth, d, can be between about 2 mm to about 12 mm, and the width, w, can be between about 0.8 mm to about 5 mm. The tilted weld 30 produces a space for a stress release packet at the weld root 24 to reduce stress concentration, whereas the weld 20 discussed earlier does not produce such a packet. Accordingly, the tilted weld 30 is able to take higher axial stresses than the weld 20. The tilt angle, α, can vary between about ±5° and ±30°. That is, the weld center line 26 can be tilted from either side of the y-axis.

The tilted weld 30 generally includes a flat surface 23 on the housing 16 side and a step surface 25 on the cover 12 side. This step surface 25 enhances mixing of the carburized layer 22 with the weld filler metal, such that the tilted weld 30 is formed of iron from the housing 16, steel from the cover 12 and the weld filler metal. (A high nickel (for example, with a minimum 15% Ni) alloy wire can be employed as the weld filler metal.) Hence, machining is not required to remove the carburized layer.

To produce the weld 30, a laser beam is directed at an angle between about ±13° from the center line 26 and is off-centered toward the iron housing 16 side or the steel cover 12 side, depending on the weld design requirements and stress conditions.

The description of the invention is merely exemplary in nature and variations that do not depart from the gist of the invention are intended to be within the scope of the invention. Such variations are not to be regarded as a departure from the spirit and scope of the invention.

What is claimed is:

1. A joint for joining two components comprising:
a weld having a center line tilted at an angle towards one of the two components, the weld including a stress release packet at a root of the weld.

2. The joint of claim 1 wherein the two components are made of dissimilar materials.

3. The joint of claim 2 wherein one of the components is made of iron.

4. The joint of claim 2 wherein one of the components is made of steel.

5. The joint of claim 1 wherein the weld has a width between about 0.8 mm to about 5 mm.

6. The joint of claim 1 wherein the weld has a depth between about 2 mm to about 12 mm.

7. The joint of claim 1 wherein the tilt angle is between about ±30°.

8. The joint of claim 7 wherein the tilt angle is between about ±5°.

9. The joint of claim 1 wherein one side of the weld includes a step surface.

10. The joint of claim 9 wherein the step surface enhances mixing of a carburized layer and a weld filler metal.

11. The joint of claim 10 wherein the weld filler metal is made of a metal with nickel.

12. The joint of claim 12 wherein the metal has a minimum of about 15% Ni.

13. The joint of claim 1 wherein the weld is produced by directing a laser beam in a region between the two components.

14. The joint of claim 13 wherein the laser beam is directed at an angle between about ±13° from the center line.

15. The joint of claim 14 wherein the laser beam is off-centered toward one of the two components.

16. The joint of claim 1 wherein the two components are components of a differential assembly.
